(19) United States
(12) Patent Application Publication
(10) Pub. No.: US 2021/0227095 A1
(43) Pub. Date: Jul. 22, 2021

(54) MODELING A PRINTED HALFTONE IMAGE

(71) Applicant: Hewlett-Packard Development Company, L.P., Spring, TX (US)

(72) Inventors: Yotam Ben-Shoshan, Ness Ziona (IL); Oren Haik, Ness Ziona (IL); Tal Frank, Ness Ziona (IL)

(73) Assignee: Hewlett-Packard Development Company, L.P., Spring, TX (US)

(21) Appl. No.: 17/265,535

(22) PCT Filed: Sep. 5, 2018
(86) PCT No.: PCT/US2018/049487

§ 371 Date: Feb. 3, 2021

(51) Int. Cl. H04N 1/52; H04N 1/405; G06N 3/08

(52) U.S. Cl. CPC H04N 1/52; G06N 3/08; H04N 1/405

(57) ABSTRACT

Certain examples described herein relate to a method in which a model for predicting a characteristic of a printed halftone image is generated. The method may include receiving sets of image data, each representing a respective image. The sets of image data may include input image data representing the respective image using a halftone pattern, and corresponding printed image data representing a printed version of the respective image printed on the basis of the halftone pattern. A training process may be iteratively performed to train a neural network to generate a mapping between input image data and printed image data. The model may be generated on the basis of the mapping. An apparatus, a system and a non-transitory computer-readable storage medium are also described.

### BACKGROUND

Printing devices operate to generate a rendered output, for example by depositing discrete amounts of a print agent, such as an ink, on a print medium, for example. In order to render an image, such as a two-dimensional photo, image data is converted into printing instructions for the printing device. In one technique, referred to as halftoning, a continuous tone image is approximated via the rendering of discrete quantities (“dots”) of an available print agent arranged in a spaced-apart configuration. Halftoning may be used to generate a grey-scale image. In some examples, halftone patterns of different colorants, such as Cyan, Magenta, Yellow and Black (CMYK) print agents may be combined to generate color images.

### BRIEF DESCRIPTION OF THE DRAWINGS

Various features of the present disclosure will be apparent from the detailed description which follows, taken in conjunction with the accompanying drawings, which together illustrate, features of certain examples, and wherein:

FIG. 1a is a schematic illustration of an apparatus according to an example;

FIG. 1b is a schematic illustration of a system according to an example;

FIG. 2 is a flow diagram showing a method according to an example;

FIG. 3 is a schematic illustration of a neural network according to an example;

FIG. 4 is a schematic illustration showing processing in a deconvolution layer according to an example;

FIG. 5 is a table showing example results of testing a neural network according to an example;

FIG. 6 shows a comparison between inputs and outputs to a mathematical model according to an example and ground truth printing results; and

FIG. 7 is a schematic illustration showing a non-transitory computer-readable storage medium according to an example.

### DETAILED DESCRIPTION

Certain examples described herein relate to halftoning. For example, a printed image may appear to have continuous tone from a distance, e.g. colors “blend” into each other. However, when inspected at close range, the printed image is found to be constructed from discrete deposit patterns. Comparative colorant channel approaches to halftoning involve a color separation stage that specifies colorant amounts to match colors within the image to be rendered; e.g. in a printing system, it determines how much of each of the available print agents (which may be inks or other imaging materials) are to be used for printing a given color. For example, a given output color in a CMYK printer may be set as 30% Cyan, 30% Magenta, 40% Yellow and 0% Black (e.g. in a four element vector where each element corresponds to an available colorant). Input colors in an image to be rendered are mapped to such output colors. Following this, when using colorant channel approaches, halftoning involves making a spatial choice as to where to apply each colorant in turn, given the colorant amounts from the color separation stage. For a printing device, this may comprise determining a drop pattern for each print agent, wherein the drop patterns for the set of print agents are layered together and printed.

The terms “halftone screen” and “halftone pattern” refer to the pattern of dots applied to produce an image, and may be defined by characteristics such as a number of lines per inch (LPI) (the number of dots per inch measured along the axis of a row of dots), a screen angle (defining the angle of the axis of a row of dots) and a dot shape (for example, circular, elliptical or square). In some examples a halftone screen is created using amplitude modulation (AM), in which a variation in dot size in a regular grid of dots is used to vary the image tone. In other examples, a halftone screen is created using frequency modulation (FM) (also referred to as “stochastic screening”), in which a pseudo-random distribution of dots is used, and the image tone is varied by varying the density of dots.

Different halftone screens may be suitable for different types of images having different characteristics. For example, halftone screens with a high LPI may be more suitable for images with many small details, whereas halftone screens with a low LPI may produce lower graininess and therefore be more suitable for representing smooth areas. Different halftone screens may therefore be designed for different purposes.

When designing a halftone screen, a halftone version of an original image created using the halftone screen may be rendered on a display (for example, a computer screen) and compared with the original image to assess how faithfully the halftone image reproduces the original image. However, when the halftone image is printed using a printing device, it may appear differently. This may be due to, for example, distortions that occur during the printing process.

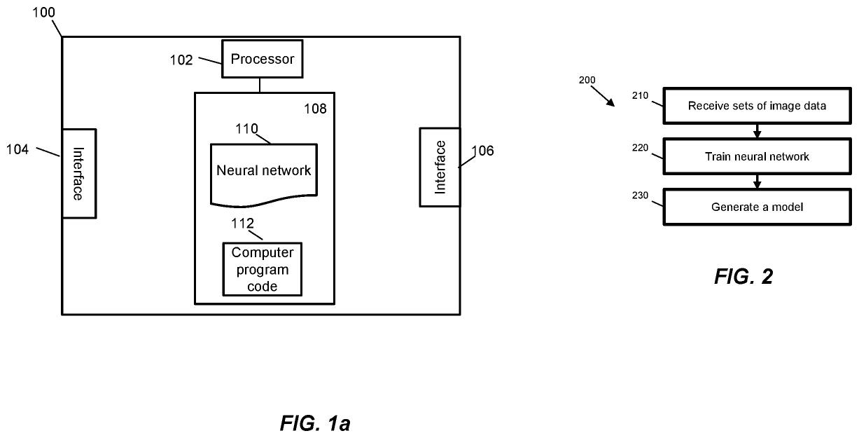

FIG. 1a shows an example of an apparatus, in the form of a computing apparatus 100, for generating a model for predicting a characteristic of a printed halftone image. The computing apparatus 100 may comprise an independent device, such as a computer, or may comprise part of a printer, for example. The computing apparatus 100 in FIG. 1 comprises a processor 102, a first interface 104, a second interface 106 and a storage media 108. The processor 102 may comprise more than one processing units, for example more than one core. The processor 102 may form part of an integrated control circuit, such as an Application Specific Integrated Circuit (ASIC) or Field Programmable Gate Array (FPGA). The storage media 104 may be a non-transitory computer-readable storage medium and may comprise data storage electronics such as registers, memory and/or storage devices. Registers and memory may comprise random access memory (RAM) and/or read-only memory (ROM), where in the latter case, the memory may comprise an electrically erasable programmable read-only memory (EEPROM). The storage media 104 may comprise multiple independent storage media, or may comprise different portions of a common storage medium, e.g. different portions of a memory, solid state storage device and/or hard disk drive. The first interface 106 comprises an input image data interface to receive input image data. The first interface 106 may comprise an interface for an internal control bus, or an interface for an external communications medium, such as a Universal Serial Bus connection or a network coupling. The second interface 108 comprises a printed image data interface to receive printed image data. The first interface 106 may comprise an interface for an internal control bus, or an interface for an external communications medium, such as a Universal Serial Bus connection or a network coupling. In some examples, the first interface 106 is the same interface as the second interface 108.

In FIG. 1a, the storage media 104 is communicatively coupled to the at least one processor 102 and is arranged to store a neural network 110 and computer program code 112. The neural network 110 may comprise a convolutional neural network (CNN), for example. The computer program code 112 may comprise instructions that can be executed by the processor 102.

FIG. 1b illustrates a system 150 according to an example, of which the computing apparatus 100 of FIG. 1a may form a part. The system 150 includes a halftone generating device 154, in the form of a halftone simulator 154, which is arranged to generate a halftone image 152b based on an original image 152a; the halftone image 152b is provided as input image data 152b to the neural network 110, and is referred to herein as “input image data”. The halftone image 152b may be generated based on a halftone screen specified by a user, such as a halftone screen designer, for example, which is provided as input to the halftone simulator 154.

The system 150 may include a printer 156, which may receive instructions to print an image corresponding to the halftone image 142 on a printing medium, such as paper, generating a printing medium image 152c. In one example, the printer 156 comprises a printing press. The system 150 may include a scanner 158 to scan the printing medium image 152c to generate printed image data 152d, which may be a digital image, for example. The scanner 158 may be an automated scanner comprising a microscope (not shown) capable of capturing high-resolution images from the printing medium image 152c, for example a resolution of 4800 dots per inch (DPI).

As mentioned above, the computing apparatus 100 storing the neural network 110 of FIG. 1a may form part of the system 150. As described in more detail below, the computing apparatus 100 may be to train the neural network 110 by performing a training process including receiving the halftone image 152b as input image data, generating an output image 152e using the neural network 110 and comparing the output image 152e with the printed image data 158d, and generate a model 160 for predicting a characteristic of a printed halftone image on the basis of the trained neural network.

In FIG. 1b, the halftone simulator 156, printer 156 and scanner 158 are shown and devices independent from one another and independent from the computing apparatus 100. In other examples, other arrangements are used. For example, the halftone simulator 154, printer 156 or scanner 158 may form part of the computing apparatus 100. For example, as mentioned above, the computing apparatus 100 may form part of a printer, such as printer 156.

The input image data 152b and corresponding printed image data 152d (each derived from the original image 152a) may be considered to form a set of image data. The input image data 152b and printed image data 152d may take the form of data files, such as digital data files, for example. The digital data files may have a format such as TIF, JPG, PNG or GIF (e.g. a lossless version of one of these formats), for example.

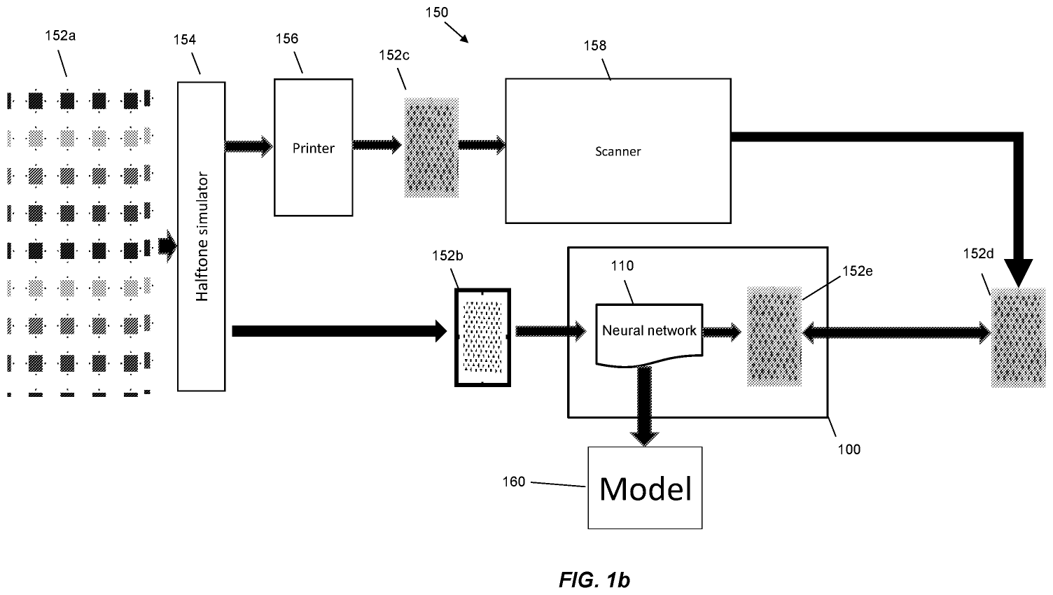

FIG. 2 illustrates a method 200 which may be performed by the computing apparatus 100, for example in use as part of the system 150. In one example, the computer program code 112 may cause the processor 102 to perform the method 200.

At 210, the computing apparatus 100 receives a plurality of sets of image data, each set of image data representing a respective image (original image 152a), using a halftone pattern (halftone screen). The original image 152a may be the whole or part of a digital image, for example. As described above, each of the sets of image data may comprise input image data 152b representing the original image and corresponding printed image data 152d representing a printed version of the original image portion printed on the basis of the halftone pattern. The input image data 152b may be a representation, such as a digital representation of the intended halftone screen e.g. with dots at locations and of sizes as theoretically expected. The corresponding printed image data 152d may be generated based on a printed version of the input image data 152b. For example, the corresponding printed image data may be generated by scanning a printing medium image 152c using a scanner device, such as scanner 158, the printing medium image 152c being generated by printing an image on a printing medium based on the input image data, as described above.

The sets of image data may each relate to different portions of the original image 152a, for example. The different portions may be mutually exclusive portions, or overlapping portions, of the original image 152a. In some examples, the sets of image data relate to different original images 152a.

At 220, the processor trains the neural network 110 to generate a mapping between input image data 152b and printed image data 152d by iteratively performing a training process. The training process may comprise providing given input image data from a given set of the plurality of sets of image data as an input to the neural network 110. An output of the neural network 110, such as the output image 152e, generated on the basis of the given input image data may be compared with given corresponding printed image data 152d from the given set of the plurality of sets of image data. In an example, the printed image data 152d is used as ground-truth data, and the parameters of the neural network 110 are adjusted so as to reduce, for example to minimize, a loss between the an output image 152e and the printed image data.

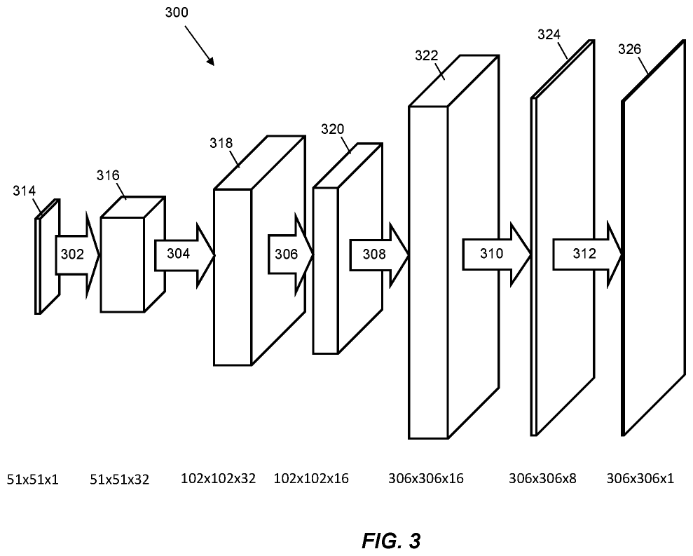

In an example, the printed image data 152d has a higher resolution than the input image data 152b. For example, the printed image data 152d may have six times the resolution of the input image data 152b (in units of LPI). Using high resolution printed image data may enable a more accurate reflection of the image as perceived by a user. For a given image area, this means that the amount of data (the size) of the printed image data is larger than the amount of data (the size) of the input image data. In order to map between the images of different size, the neural network 110 may include a deconvolution layer (also referred to as a transpose convolution layer). Examples of the neural network 110 and the training process are described in more detail below with reference to FIG. 3.

At 230, the processor 102 generates a model, such as a mathematical model, for predicting a characteristic of a printed halftone image on the basis of the mapping. In an example, the model comprises the trained neural network 110 itself, or a representation of same. The model 160 may be saved to a storage media, for example, and include computer-executable instructions. These instructions may be subsequently used on a computing device, such as a general-purpose computer for example, to predict a characteristic of a printed halftone image based on input image data using a given halftone pattern, for example. The predicted characteristic may comprise for example, a dot size or location, or a deviation of same from an intended value, for example. In one example, predicting a characteristic may comprise producing a halftone image (for example, a digital image to be rendered on a computer screen) representing the predicted printed halftone image.

The method 200 described above enables a halftone printing process to be modeled by treating the printing process as a “black box”. This is simpler and more accurate than an analytic approach in which it is attempted to model the various different stages of the printing process individually.

In some examples, different models 160 may be generated for different types of halftone pattern. For example, one model 160 may be generated for halftone screens having a given LPI or range of LPIs. In this case, the plurality of sets of image data described above may comprise a first type of halftone pattern relating to a first type of halftone patter and a second plurality of sets of image data relating to a second type of halftone pattern. A first model 160 may then be generated for predicting a characteristic of a printed halftone image for the first type of halftone pattern based on the first plurality of sets of image data, and a second model 160 generated for predicting a characteristic of a printed halftone image for the second type of halftone pattern. In this case, the plurality of sets of image data described above may comprise a first plurality of sets of image data each representing a respective image of a first color and a second plurality of sets of image data each representing a respective image of a second color. A first model 160 may then be generated for predicting a characteristic of a printed halftone image of the first color based on the first plurality of sets of image data, and a second model 160 generated for predicting a characteristic of a printed halftone image of the second color based on the second plurality of sets of image data.

Similarly, different models 160 may be generated for different types (for example, different models) of printer, in order to take account of the different characteristics of the different types of printers.

As mentioned above, in an example, the computing apparatus 100 may comprise part of printer. Such an arrangement may be used to train the neural network 110 to generate a model 160 specifically tailored to the particular individual printer. For example, the printer may be used to print an image portion on a printing medium (for example, paper) based on the input image data to generate a printing medium image. The printing medium image may then scanned, using a scanner function of the printer for example, to generate the corresponding printing image data. This enables a model 160 to be generated reflecting the characteristics of an individual printer. In this example (as well as other examples), part of the training process may be performed on a device different from the computing device 100. The training process performed on the computing device 100 may take the form of a calibration process, for example using a single set of input image data and corresponding printed image data, or a relatively small number of such sets.

FIG. 3 illustrates an example neural network 110 in the form of a convolutional neural network (CNN) 300. The CNN 300 includes filters 302 to 312. In FIG. 3, the feature maps, which may be referred to as “layers”, are represented by blocks 314 to 326. An example feature map size of each respective data set is also shown.

In the example of FIG. 3, feature map 314 is derived from the input image data 152b. For example, the input image data 152b may be subject to a patch extraction and representation process, in which patches (sections) may be extracted from the input image data 152d and represented as feature vectors forming the feature map 314. Feature map 312 may comprise a feature map of such a patch. Filters 304 to 310 are mapping filters, for example, linear mapping features, which map the feature vectors onto further feature vectors. The example CNN 300 may comprise neurons having non-linear activation functions which, combined with a linear filter, enable a non-linear mapping. In the present example, filter 302 is a Cony 3×2×32+Batch Normalization (BN) filter, filter 304 is a ConvD2Transpose 2×2 layer, filter 306 is a Cony 3×3×16+BN filter, filter 308 is a Conv2DTranspose 3×3 layer, layer 310 is a Cony 3×3×8+BN filter and filter 312 is Cony 1×1×1 reconstruction filter. As described above, the CNN 300 may be trained by comparing the reconstructed image 152e to the printed image data 152d, and adjusting the parameters (for example, filter weights) in the layers 302 to 312 to minimize the loss between the reconstructed image 152e and the printed image data 152d.

In one example, a Mean Average Error (MAE) loss function may be used as the loss value to be minimised, as illustrated in equation (1):

MAE=Σₙ₌₀^{all}|Img_{GT}−Img_{P}| Equation (1)

In another example, an accuracy loss function may be used, as illustrated in equation (2):

$$ACURRACY = \frac{\vert \overline{{Img}_{GT}} \cdot \overline{{Img}_{P}} \vert + \vert {Img}_{GT} \cdot {Img}_{P} \vert}{\vert All \vert} \qquad Equation 2$$

In equations (1) and (2) Img_{GT} is a feature vector in the printed image data 152 and Img_{P} is a feature vector in the output image 152e.

As mentioned above, in order to accommodate cases where the image size of the printed image data (and therefore the size of the reconstructed image data) is larger than that of the input image data, the CNN 300 may include a deconvolution layer to map between images of different sizes. In the example of FIG. 3, layer 304 and layer 308 are deconvolution layers.

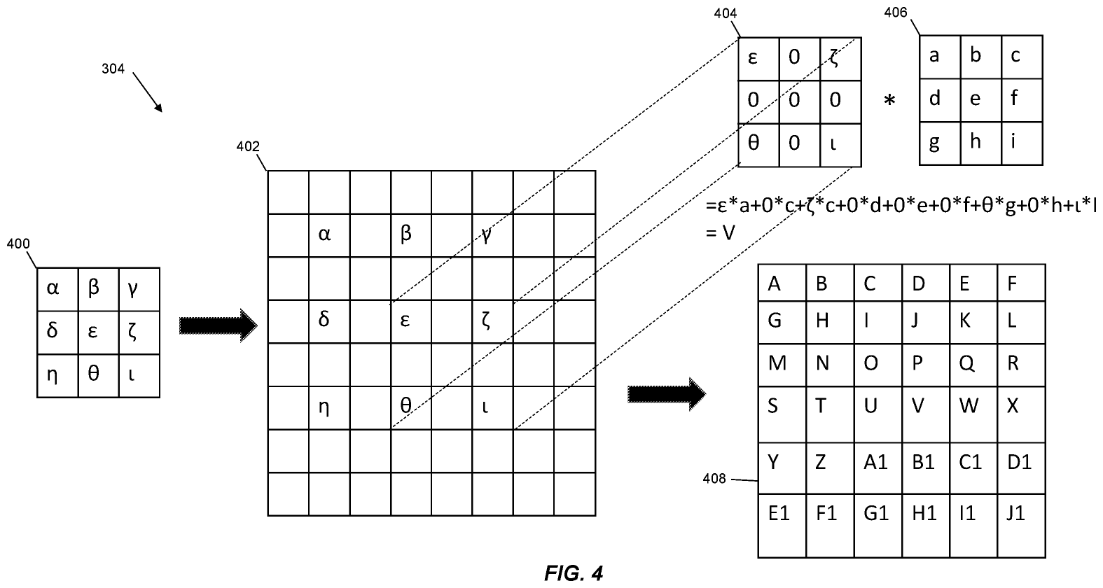

FIG. 4 shows an example of processing performed by deconvolution layer 304. Grid 400 shows a part of data set 314 input to the deconvolution layer 304, having 3*3 values represented by α to ι. The data set size is increased to 8×8 to form a padded data set 402 having 8*8 values, by interspersing values α to ι amongst values set at zero (“padding”); in 402 in FIG. 4, the blank grid entries represent zero values. 3*3 subsets are extracted from the padded data set in sequence from the padded data set 402 and a filter 406 applied to each extracted subset in turn. For example, a first subset may be extracted from a 3*3 window having upper left corner at the upper left corner of the padded data set 402, with the window being shifted in sequence along the uppermost rows of padded data set 402, before moving downwards along the column direction and sequentially shifting again in a row direction. In FIG. 4, an example subset 404 is shown.

As mentioned, a filter 406 is applied to each extracted subset. Example filter 406 includes parameter values a to i. In an example, the filter 406 is applied by multiplying each value of the subset 404 by a parameter value at a corresponding position in the filter 406, and summing the resulting products for all positions, the resulting sum is then used as a value at a position in the data set 316 which forms the output of the deconvolution layer 304. Grid 408 in FIG. 4 shows an example part of the output data set 316. In the example shown, the filter 406 is applied to subset 404 to generate value V in grid 408. The parameter values a to i of the filter 406 are examples of the parameter values which may be varied during the process of training the neural network 110.

In some examples, a different type of neural network 110 to the CNN 300 illustrated in FIG. 3 is used. For example, a U-Net modified to include a deconvolution layer as described above (herein referred to as a “modified U-net) may be used.

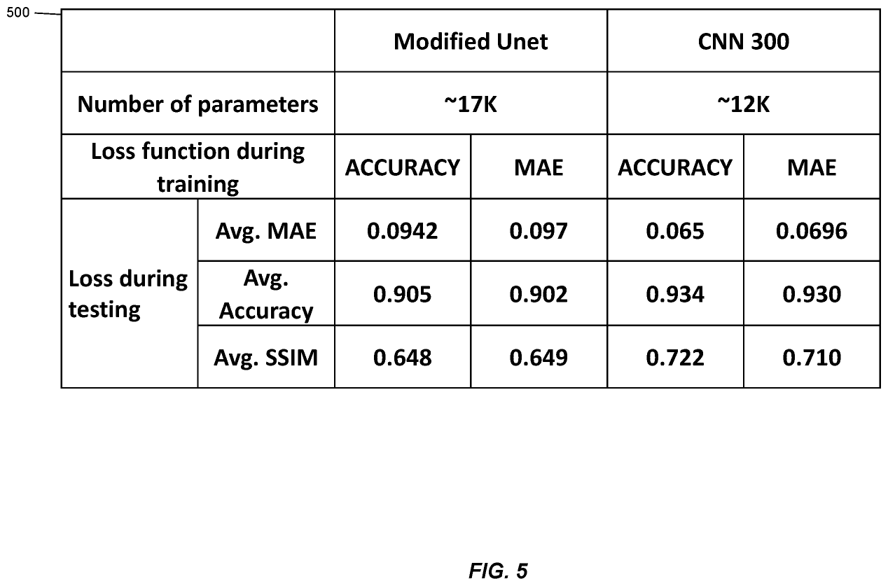

FIG. 5 shows a table comparing results of testing using the neural network 110 in the case that the neural network 110 is the modified U-Net and in the case that the neural network 110 is the CNN 300 illustrated in FIG. 3, and, for each type of neural network, in the case that the loss function used during training is an accuracy function as illustrated in equation (2) and in the case that the loss function is a MAE function as illustrated in equation (1). During testing, average MAE, average accuracy and average SSIM (structural similarity) were obtained as measures of performance. In the example of FIG. 5, the modified Unet tested has approximately 12,000 parameter and the CNN 300 tested has approximately 17,000 parameters. The number of parameters used in this example CNN 300 has a good ration with the number of sampled data points, meaning that there is a low chance of overfit occurring. It can be seen that the best results are obtained according to all measures using the CNN 300 of FIG. 3 and the accuracy loss function.

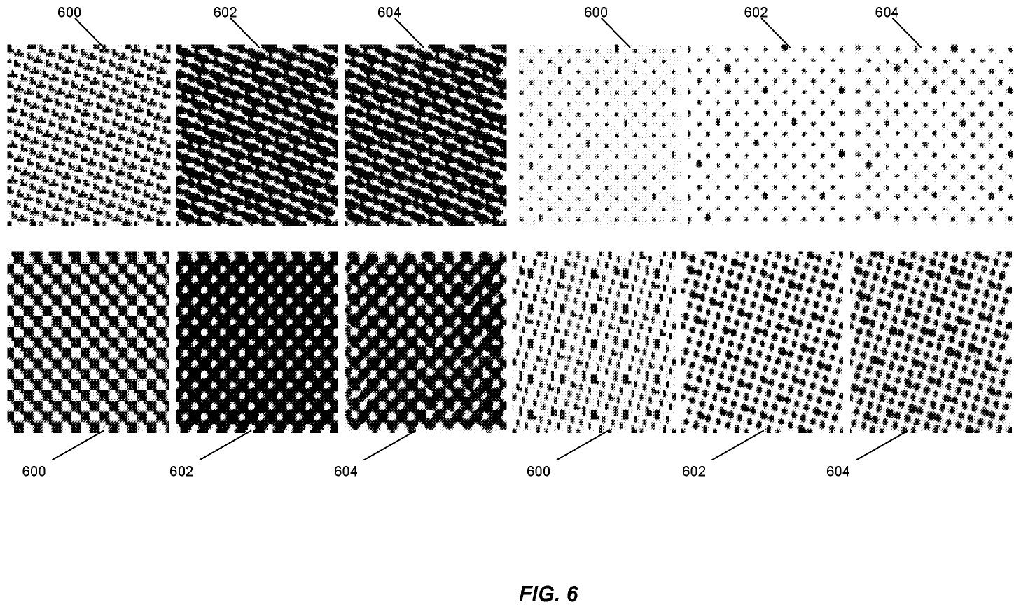

FIG. 6 shows images illustrating the output of the model 160. The images labelled 600 are input images corresponding to the input image data 152b, the images labelled 602 are model-predicted images corresponding to the output image data 152e and the images labelled 604 are ground truth images corresponding to printed image data 152d. By comparison between the images 602 and 604 it can be seen that there is a close visual correspondence between the model prediction and the ground truth.

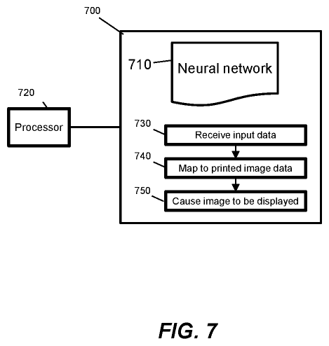

As mentioned above, a model 160 generated by the methods described above may be saved to a computer-readable storage medium, which may include computer-readable instructions, and which may be executed by a computing device such as a general purpose computing device. FIG. 7 shows an example of a non-transitory storage medium 700 storing such a model, in the form of a neural network 710 trained to provide a mapping between input image data representing a respective image using a halftone image pattern and printed image data representing a printed version of the respective image printed on the basis of the halftone pattern. The storage medium stores instructions that when executed by a processor 720 cause the processor to perform a series of operations. The processor 720 may form part of a computing device, as mentioned above. The processor may be instructed via instruction 730 to receive given input image data representing a given respective image using a halftone image pattern. The processor 720 may be instructed via instruction 740 to use the neural network 710 to map the given input image data to generate printed image data representing a printed version of the given respective image. The processor may be instructed via instruction 760 to cause the printed version of the given respective image to be displayed on a display screen, for example a display screen of the computing device including the processor 720. This enables a model 160 to be used by a user, such as a halftone screen designer, to predict a characteristic, such as an appearance, of a halftone image as it would appear if printed, without requiring printing of the halftone image.

The preceding description has been presented to illustrate and describe examples of the principles described. This description is not intended to be exhaustive or to limit these principles to any precise form disclosed. Features of individual examples may be combined in different configurations, including those not explicitly set out herein. Many modifications and variations are possible in light of the above teaching.

1. A method, comprising:
receiving a plurality of sets of image data, each set of image data representing a respective image and comprising:
input image data representing the respective image using a halftone pattern; and
corresponding printed image data representing a printed version of the respective image printed on the basis of the halftone pattern;
iteratively performing a training process to train a neural network to generate a mapping between input image data and printed image data, the training process comprising:
providing given input image data from a given set of the plurality of sets of image data as an input to the neural network; and
comparing an output of the neural network with given corresponding printed image data from the given set of the plurality of sets of image, the output of the neural network being generated on the basis of the given input image data; and
generating a model for predicting a characteristic of a printed halftone image on the basis of the mapping.

2. The method of claim 1, wherein the output of the neural network comprises reconstructed image data representing a reconstructed version of the respective image.

3. The method according to claim 2, wherein the input image data has a first resolution and the corresponding reconstructed image data has a second resolution, the second resolution being higher than the first resolution.

4. The method according to claim 3, wherein the printed image data has a resolution substantially the same as the reconstructed image data.

5. The medium according to claim 3, wherein the neural network comprises a deconvolution layer to map between the first resolution and the second resolution.

6. The method of claim 1, wherein the training process comprises adjusting values of parameters of the neural network based on the comparison.

7. The method of claim 6, comprising adjusting the values of the parameters so as to reduce a loss value between the output of the neural network and the printed image data.

8. The method according to claim 1, wherein the plurality of sets of image data comprises a first plurality of sets of image data relating to a first type of halftone pattern and a second plurality of sets of image data relating to a second type of halftone pattern, and the method comprises:
generating a first model for predicting a characteristic of a printed halftone image for the first type of halftone pattern based on the first plurality of sets of image data; and
generating a second model for predicting a characteristic of a printed halftone image for the second type of halftone pattern based on the second plurality of sets of image data.

9. The method according to claim 1, wherein the plurality of sets of image data comprises a first plurality of sets of image data each representing a respective image of a first color and a second plurality of sets of image data each representing a respective image of a second color, and the method comprises
generating a first model for predicting a characteristic of a printed halftone image for the first color based on the first plurality of sets of image data; and
generating a second model for predicting a characteristic of a printed halftone image for the second color based on the second plurality of sets of image data.

10. An apparatus, comprising:
a processor;
an input image data interface to receive input image data representing a respective image using a halftone image pattern;
a printed image data interface to receive corresponding printed image data representing a printed version of the respective image printed on the basis of the halftone pattern;
storage media, communicatively coupled to the processor, to store:
a neural network; and
computer program code to instruct the processor to:
train the neural network by providing the input image data as an input to the neural network and comparing the corresponding printed image data with an output from the neural network to generate a trained neural network;
generate a model for predicting a characteristic of a printed halftone image on the basis of the trained neural network.

11. The apparatus according to claim 10, wherein the neural network comprises a convolutional neural network.

12. The apparatus according to claim 10, wherein the neural network comprises a deconvolution layer to map between input image data having a first image size and corresponding printed image data having a second image size, the second image size being larger than the first image size.

13. The apparatus according to claim 10, comprising:
a printer to print the respective image on a printing medium based on the input image data to generate a printing image medium; and
a scanner to scan the printing medium image to generate the corresponding printing image data.

14. A system, comprising:
a storage medium to store a neural network;
a halftone image generating device to generate a halftone image using a halftone screen;
a printer to print the halftone image on a printing medium based to generate a printing medium image;
a scanner to scan the printing medium image to generate printed image data; and
a processor to train the neural network by providing the input image data as an input to the neural network and comparing an output of the neural network with the corresponding printed image data.

15. (canceled)
